(19) United States
(12) Patent Application Publication
(10) Pub. No.: US 2026/0226894 A1
(43) Pub. Date: Aug. 6, 2026

(54) STATOR WITH NON-UNIFORM THICKNESS FOR ONE-TO-TWO LOBE RATIO PUMPS

(71) Applicant: SCHLUMBERGER TECHNOLOGY CORPORATION, Sugar Land, TX (US)

(72) Inventors: Maxim PUSHKAREV, Lawrence, KS (US); Peter HONDRED, Lawrence, KS (US); Jason HOLZMUELLER, Lawrence, KS (US); William GOERTZEN, Lawrence, KS (US)

(21) Appl. No.: 19/142,236

(22) PCT Filed: Dec. 19, 2023
(86) PCT No.: PCT/US2023/084755

§ 371 Date: Jun. 23, 2025

Related U.S. Application Data
(60) Provisional application No. 63/434,638, filed on Dec. 22, 2022.

(51) Int. Cl. F04C 13/00; F04C 2/08; F04C 2/107

(52) U.S. Cl. CPC F04C 13/008; F04C 2/086; F04C 2/1071; F04C 2240/10

(57) ABSTRACT

A fluid displacement pump can include a rotor; and a stator, where the stator includes an elastomeric material with a non-uniform thickness, and where the rotor and the stator have a one-to-two lobe ratio.

### CROSS REFERENCE TO RELATED APPLICATIONS

This application claims the benefit of U.S. Provisional Patent Application No. 63/434,638 filed Dec. 22, 2022, the entire contents of which are hereby incorporated by reference in their entirety.

### BACKGROUND

In many well applications, electric submersible pumps (ESPs) are deployed downhole to provide artificial lift for lifting oil to a collection location. An ESP has a series of centrifugal pump stages contained within a protective housing and mated to a submersible electric motor. The ESP may be installed at the end of a production string and is powered and controlled via an armor protected cable. Electric submersible pumps may be used in a variety of moderate-to-high-production rate wells; however, each ESP may be designed for a specific well and for a relatively tight range of pumping rates.

As the well pressure and volume taper off, the ESP can begin to operate outside of the specified range. This results in substantial reductions in system efficiencies and can lead to major mechanical problems, excessive energy costs, and premature pumping system failure. When the efficiency of the pump has been reduced, an operator may transition to a low flow solution such as a sucker rod pump or similar system which can accommodate the lower production volumes. However, such low flow systems have relatively limited applications and often cannot be deployed in unconventional deviated wells, e.g., horizontal wells.

### SUMMARY

A fluid displacement pump can include a rotor; and a stator, where the stator includes an elastomeric material with a non-uniform thickness, and where the rotor and the stator have a one-to-two lobe ratio.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a schematic illustration of an example of an electric submersible progressive cavity pumping system having a progressive cavity pump and being deployed downhole in a borehole, e.g., a wellbore, according to an embodiment of the disclosure;

FIG. 2 is a cross-sectional view of an example of a progressive cavity pump, according to an embodiment of the disclosure;

FIG. 3 is an orthogonal view of an example of a progressive cavity pump composite stator for use with an electric submersible progressive cavity pump, the composite stator illustration being partially broken away to show examples of composite layers, according to an embodiment of the disclosure;

FIG. 4 is an end view of an example of a composite stator, according to an embodiment of the disclosure;

FIG. 5 is an orthogonal view, partially broken away, of an example of a progressive cavity pump composite stator combined with a rotor to form an electric submersible progressive cavity pump, according to an embodiment of the disclosure;

FIG. 6 is a series of diagrams of examples of pumps;

FIG. 7 is an example of a plot;

FIG. 8 is a photograph of an example of a failed stator;

FIG. 9 is a series of diagrams of examples of pump components;

FIG. 10 is a series of diagrams of examples of pump operations;

FIG. 11 is a series of diagrams of examples of pump components;

FIG. 12 is a series of diagrams of examples of pump components;

FIG. 13 is a series of plots for examples of pumps;

FIG. 14 is a series of plots for examples of pumps;

FIG. 15 is a plot for examples of pumps;

FIG. 16 is a series of plots for examples of pumps;

FIG. 17 is a series of diagrams of examples of pump components;

FIG. 18 is a series of plots for examples of pumps;

FIG. 19 is a series of plots for examples of pumps;

FIG. 20 is a plot for examples of pumps;

FIG. 21 is a series of plots for examples of pumps;

FIG. 22 is a series of diagrams of examples of pump components;

FIG. 23 is a diagram of an example of a method; and

FIG. 24 is a diagram of computing devices.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The disclosure herein generally involves a system and methodology for facilitating efficient well production in relatively low volume applications, e.g., applications after well pressure and volume taper off for a given well. According to an embodiment, use of an electric submersible progressive cavity pump is enabled in harsh, high temperature downhole environments. In some applications, an ESP system may initially be used to pump fluid, e.g., oil, from the well while the volume of flow is moderate to high. However, after the volume of flow tapers off and the ESP efficiency drops a sufficient degree, the ESP system is then removed and replaced by the electric submersible progressive cavity pump. Substitution of the electric submersible progressive cavity pump provides a seamless way for continuing efficient production. As explained in greater detail below, the electric submersible progressive cavity pump is constructed for long-term use even in the high temperature, harsh downhole environment.

Long-term, efficient use of the progressive cavity pump in harsh downhole environments is facilitated with a composite pump stator. The composite stator can include an outer housing and a thermoset resin layer located within the outer housing and secured to the outer housing. The thermoset resin layer is constructed with an internal surface having an internal thread design, e.g., a helical thread design. Additionally, an elastomeric layer is located within (e.g., radially within and/or on or adjacent an inner surface of) the thermoset resin layer and has a shape which follows the internal thread. In this manner, the elastomeric layer is able to provide an interior surface generally matching the shape of the internal thread of the thermoset resin layer. The arrangement of the layers and the materials selected for the layers provide a composite stator structure which has great longevity in harsh, high temperature downhole environments while providing an appropriate surface for creating pumping cavities along which fluid is pumped when an internal rotor is rotated relative to the composite pump stator. The inner elastomer layer may be initially formed as an extruded tube which is then inserted into an interior of the intermediate thermoset layer. The extruded tube conforms to the thread pattern and provides an enhanced surface interface with the rotor.

According to an embodiment, the electric submersible progressive cavity pump system combines a progressive cavity pump with a motor and a gearbox that can be submersible and may be fully submersed downhole. This allows the electric submersible progressive cavity pump system to be constructed as a drop-in replacement for an ESP and to utilize the same surface equipment. As a result, continued production can be maintained on a cost effective basis. Additionally, use of a progressive cavity pump enables use of the overall electric submersible progressive cavity pump system in a wide variety of wells including unconventional deviated wells, e.g., horizontal wells.

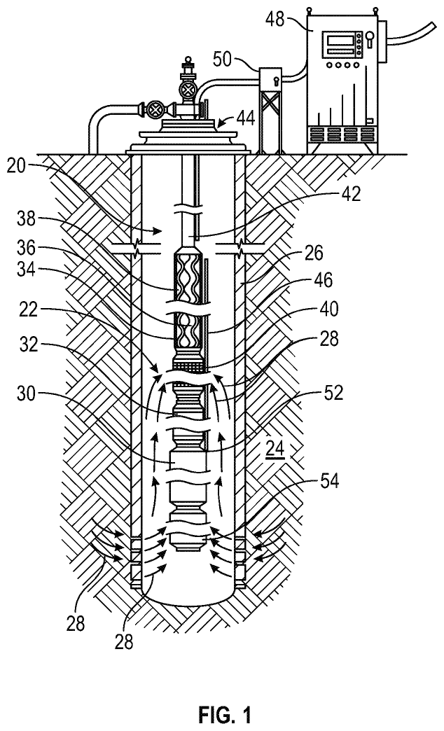

Referring generally to FIG. 1, an example of an electric submersible progressive cavity pump system 20 is illustrated as deployed in a borehole 22, e.g., a wellbore. In this embodiment, the wellbore 22 is drilled into a subterranean formation 24 and, in some applications, may be lined with casing 26. Perforations are formed through the casing 26 and out into the surrounding formation 24 to enable the inflow of oil 28 and/or other fluids which may then be pumped to a collection location via the electric submersible progressive cavity pump system 20.

According to the example illustrated, the electric submersible progressive cavity pump system 20 may comprise a submersible motor 30, e.g., an induction motor or a PMM (permanent magnet motor), a submersible gearbox 32 driven by the motor 30, and a progressive cavity pump 34 driven via the gearbox 32. The progressive cavity pump 34 may comprise a rotor 36 rotatably positioned within a surrounding composite stator 38. The motor 30 and gearbox 32 may be used to drive/rotate the rotor 36 within the composite stator 38 to pump fluid, e.g., oil 28. For example, the oil 28 entering wellbore 22 may be drawn in through a pump intake 40 and pumped via progressive cavity pump 34 up through a tubing 42, e.g., a production tubing. From tubing 42, the pumped fluid may be directed through a wellhead 44 to an appropriate surface collection location.

Electric power may be provided downhole to the submersible motor 30 via a power cable 46. In the example illustrated, the power cable 46 is routed along the tubing 42 and connected with a power source 48, e.g., a variable speed drive or switchboard, via a cable junction box 50. However, appropriate electrical power may be provided to the downhole motor 30 via various types of power supply systems. The power cable 46 is connected to the motor 30 by a sealed motor electrical connector 52.

Depending on the parameters of a given application, the electric submersible progressive cavity pump system 20 may comprise a variety of other components and/or may be coupled with a variety of other components and systems. By way of example, various shaft seals, motor protectors, and other components may be connected with, or integrated into, the motor 30 and/or gearbox 32. In the illustrated example, a lower component 54 is coupled with motor 30 on a downhole side of the motor 30. By way of example, the lower component 54 may be an oil compensator or a base gauge. However, many other types of components and systems may be connected with or used in combination with the electric submersible progressive cavity pump system 20.

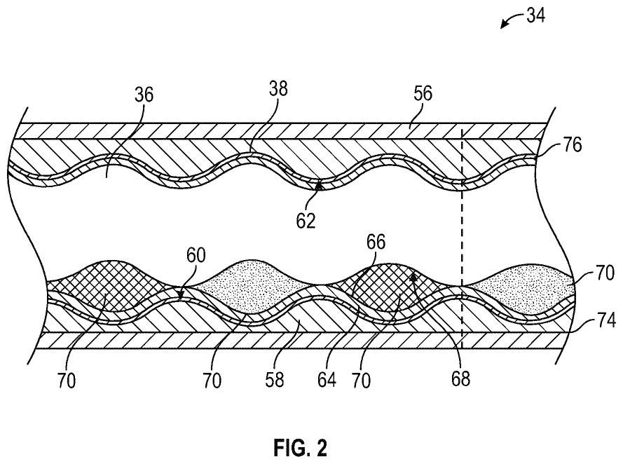

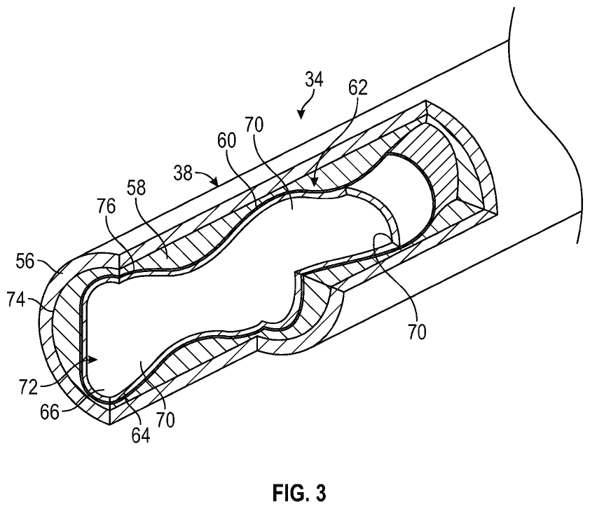

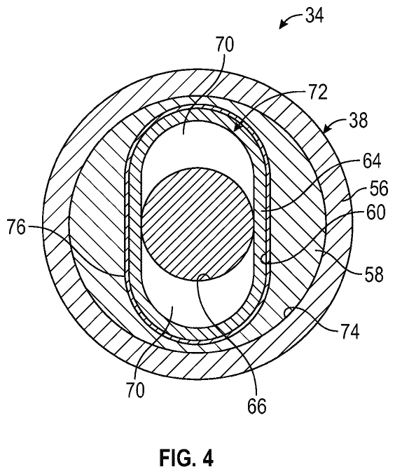

With additional reference to FIG. 2, an embodiment of the composite stator 38 of progressive cavity pump 34 comprises an outer housing 56, e.g., a metal outer housing, and a first layer 58 located within (e.g., radially within) the outer housing 56. The first layer 58 may be formed from a thermoset resin and may be secured to the outer housing 56 along an interior surface of the outer housing 56. The first layer 58 is molded or otherwise constructed to have an interior surface 60 formed as an internal thread 62. For example, the internal thread 62 may be formed as a helical thread (see also FIGS. 3 and 4).

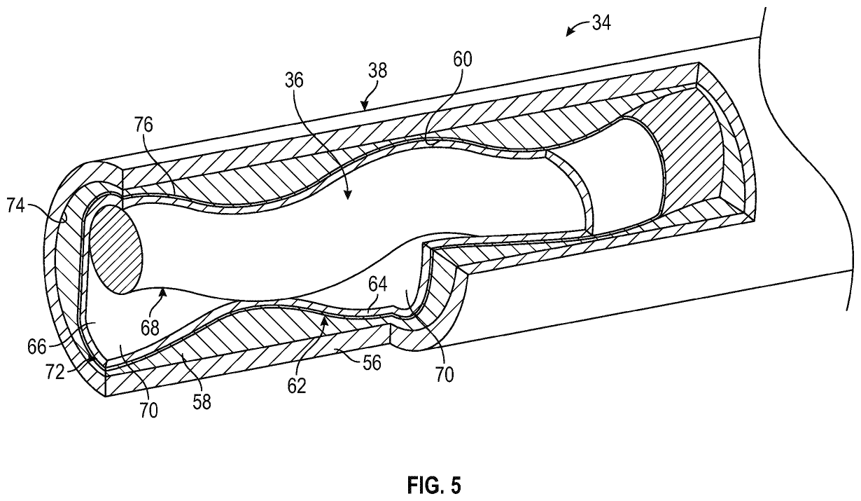

The illustrated composite stator 38 further comprises a second layer 64 located within (e.g., radially within and/or on or adjacent an inner surface of) first layer 58. The second layer 64 can be secured to the first layer 58 along the internal thread 62. The second layer 64 may be formed from an elastomer in a shape which follows the internal thread 62 such that a second layer interior surface 66 generally matches the shape of the first layer interior surface 60. In other words, the interior surface 66 of second layer 64 also presents an internal thread construction, e.g., a helical internal thread, which provides an operational interface with rotor 36. The thread configuration of interior surface 66 and a corresponding thread shaped exterior 68 of rotor 36 (see also FIG. 5) are constructed to create progressing cavities 70 along composite stator 38 as rotor 36 is rotated relative to composite stator 38. As with conventional progressive cavity pumps, rotation of rotor 36 causes these progressing stator cavities 70 to move fluid, e.g., oil 28, along the composite stator 38 until discharged, e.g., discharged into tubing 42. Thus, the elastomer layer 64 is the primary stator elastomer against which the rotor 36 rotates.

Referring again to FIGS. 3 and 4, the various layers of composite stator 38 may be constructed from various types of materials, as described in greater detail below. However, the layer materials as well as the materials/mechanisms for securing the multiple layers together are selected to enable operation at high temperatures and in aggressive fluid environments for long durations. As a result, the composite stator 38 enables long-term operation of the electric submersible progressive cavity pump system 20 in downhole environments.

In the example illustrated in FIGS. 3 and 4, the outer housing/layer 56 may be constructed from metal or other suitable material able to withstand downhole conditions. By way of example, the outer housing 56 may be constructed from various carbon steels or stainless steels. However, the outer housing 56 also may be constructed from materials such as ni-resist, nickel alloys, or other suitable materials.

With respect to the first layer 58, this layer may be constructed from a thermoset resin which may be formulated in various thermoset composites. For example, the first layer 58 may be a structural thermoset resin having a glass transition temperature greater than a desired final application temperature. Additionally, the structural thermoset resin should be capable of bonding completely with a bonding layer as discussed in greater detail below. The thermoset resin layer 58 may be constructed, e.g., molded, from a thermosetting epoxy base system having a high glass transition temperature (Tg) and good resistance to downhole conditions. One example is a thermosetting epoxy comprising CoolTherm EL-636 resin available from Parker LORD.

However, various types of epoxies may be formed from a variety of thermoset resins for use in constructing the first layer 58 and the internal thread shape. Examples of such thermoset resins and suitable materials for first layer 58 include bismaleimide, cyanate esters, preceramic thermosets, phenolics, novalacs, dicyclopentadiene-type systems, or other thermoset materials with sufficient Tg and bonding capability.

To further improve performance of the first layer 58 in various harsh operating conditions, various additives may be combined into the thermoset resin. For example, fillers may be incorporated into the thermoset resin to improve heat dissipation and to reduce the coefficient of thermal expansion (CTE). Examples of suitable fillers include mineral particles, metal powder, ceramic or organic particles, silica, alumina fillers, aluminum metal particles, or other suitable metal particles. Additionally, adhesion promoting additives may be combined into the thermoset resin layer 58 to enhance bonding to adjacent layers. In some embodiments, rubberized additives may be added to the thermoset resin layer 58 to increase toughness/fracture resistance. This could involve blending a certain amount of elastomer into the thermoset material. Various other additives may be combined to, for example, promote compatibility with the adjacent elastomer layer 64.

In the example illustrated in FIGS. 3 and 4, the second layer 64 is an elastomer layer formed as an extruded tube 72. The extruded tube 72 is inserted or positioned along the interior of the first layer 58 and is sufficiently pliable to conform to the shape of internal thread 62 so as to present its interior surface 66 in a corresponding thread pattern, e.g., a helical thread pattern. By way of example, the second layer 64 may be formed with a generally constant wall thickness. [0028] The extruded tube 72 or other types of second layer 64 may be formed from a variety of elastomers, e.g., rubbers, able to provide the desired contact and interaction with the rotor 36. The materials selected to form elastomer layer 64 also are resistant to downhole conditions, e.g., resistant to well fluids and downhole temperatures. Specific compounds may be optimized for good dynamic properties, low hysteresis, and high tensile and tear strength.

By forming the second layer 64 as an extruded tube 72, much higher viscosities can be tolerated. As a result, elastomer materials having much higher strength may be selected so as to provide a substantially greater resistance to damage. Examples of suitable elastomer materials for construction of second layer 64/extruded tube 72 include nitrile rubber (NBR), hydrogenated nitrile rubber (HNBR), and FKM fluoroelastomer, e.g., VITON™ available from The Chemours Company or Fluorel™ available from Dyneon LLC. For very high heat applications, e.g., greater than 180° C., the second layer 64/extruded tube 72 may be constructed from materials such as tetrafluoroethylene propylene (e.g., FEPM) or VITON™ Extreme ™ fluoroelastomer products available from The Chemours Company.

For example as shown in the example illustrated in FIGS. 3 and 4, the composite stator 38 may further comprise a bonding layer 74 located between the outer housing 56 and the first layer 58 and/or a middle bonding layer 76 located between the first layer 58 and the second layer 64. The bonding layer 74 may comprise a variety of materials and/or structures which are able to secure the thermoset resin of first layer 58 to the surrounding housing 56, e.g., metal housing. By way of example, the bonding layer 74 may comprise various adhesives which remain functional in the hot, harsh downhole environment. However, the bonding layer 74 also may comprise physical elements and may be formed with a molded fit, a press fit, or another type of friction fit between the first layer 58 and the surrounding outer housing 56.

With respect to bonding layer 76, this bonding layer may similarly use a variety of materials. According to an embodiment, the bonding layer 76 comprises an elastomer compound which may use the same base polymer as the elastomer of second layer 64 or other suitable variants. For example, if the elastomer layer 64 is formed from nitrile rubber with 40% acrylonitrile (ACN), the bonding layer 76 may use a similar material but with 30% ACN. However, the bonding layer 76 also can be formulated with a different type of elastomer that is at least partially compatible, e.g., forming bonding layer 76 with ethylene propylene diene monomer (EPDM) while the primary elastomer of second layer 64 is formed with hydrogenated nitrile rubber (HNBR).

In a variety of applications, the bonding layer 76 is formulated with an elastomer material capable of coextrusion and co-crosslinking with the elastomer of elastomer layer 64. Accordingly, both the bonding layer 76 and the elastomer layer 64 may be capable of using the same type of cross-linking system, although the bulk of each elastomer may use different curing systems. To facilitate longevity downhole in certain applications, the formulation of bonding layer 76 may be optimized for bonding instead of, for example, dynamic loading and high tensile strength.

Accordingly, embodiments of bonding layer 76 may utilize components and techniques known to facilitate bonding between the thermoset resin layer 58 and the elastomer layer 64. Examples of such components/techniques include using hot polymerized nitrile rubber and/or use of fillers that promote bonding, e.g., fumed and precipitated silica, diatomaceous earth, or other mineral fillers. Additional examples include the use of metal oxides that promote bonding. Such metal oxides tend to be elastomer dependent but may include zinc oxide, aluminum oxide, lead oxides, calcium oxides, magnesium oxides, iron oxides, and other suitable metal oxides.

Additional components and techniques which facilitate bonding include the use of a base polymer in bonding layer 76 with increased unsaturation (higher residual double bond content). Adhesion promoting additive polymers with high unsaturation, e.g., RICON™ 154 90% vinyl polybutadiene, also may be used in formulating bonding layer 76. There also are many multifunctional additives which promote adhesion and include, for example, maleated polybutadiene, methacrylated polybutadiene, epoxidized polybutadiene, acrylated bonding coagents, and various monomer oligomers or polymers having functionality allowing the bonding layer 76 to interact with two different systems presented by the elastomer of layer 64 and the thermoset material of layer 58.

Furthermore, the bonding layer 76 may utilize catalysts, curative agents, or reactive agents which enhance reactivity and bonding with the thermoset composite layer. The bonding layer 76 also may be formulated with various additives or according to manufacturing processes which create increased surface area to further enhance bonding with the adjacent layers, e.g., thermoset layer 58. An example of a manufacturing process which facilitates bonding is extruding the bonding layer 76 with a rough or porous surface. Depending on the material composition of both the elastomer layer 64 and the thermoset layer 58, the material of bonding layer 76 may be selected according to its ability to chemically bond with both layers 58, 64.

By using a thermoset material to form the first layer 58 with internal thread 62/stator cavities 70 and then inserting a second elastomer layer 64, the composite stator 38 is relatively inexpensive to construct. As described above, the construction of elastomer layer 64, e.g., extrusion of elastomer layer 64 as tube 72, in combination with selecting suitable layer materials described herein and bonding elastomer layer 64 to the first layer 58 via bonding layer 76 provides a composite stator 38 which has a high resistance to temperature and well fluid. This allows use of the composite stator 38 over long periods of time in a variety of downhole applications.

The securely bonded elastomer layer 64 also presents a rugged, long-lasting interior surface 66 for long-term interaction with rotor 36, as illustrated in FIG. 5. Once the rotor 36 is inserted into the composite stator 38 and the overall electric submersible progressive cavity pump system 20 is assembled, the pump system 20 may be deployed downhole into a variety of wellbores 22, including many types of deviated, e.g., horizontal, wellbores for production of oil 28 or other downhole fluids. The electric submersible progressive cavity pumping system 20 may initially be employed as the primary artificial lift system. In a variety of applications, however, a conventional ESP system may initially be employed to pump oil and/or other downhole fluids until well pressure and production rate taper off sufficiently to render the conventional ESP system undesirably inefficient. At that time, the conventional ESP system may be removed and replaced with the electric submersible progressive cavity pump system 20 for efficient well production at a lower flowrate.

The composite structure of stator 38 may be adjusted according to parameters of a given downhole environment and/or pumping application. Additionally, the progressive cavity pump 34 may be constructed in a variety of sizes and configurations. Many types of additional or other components may be incorporated into the overall electric submersible progressive cavity pump system 20 for use in various types and sizes of boreholes, e.g., wellbores.

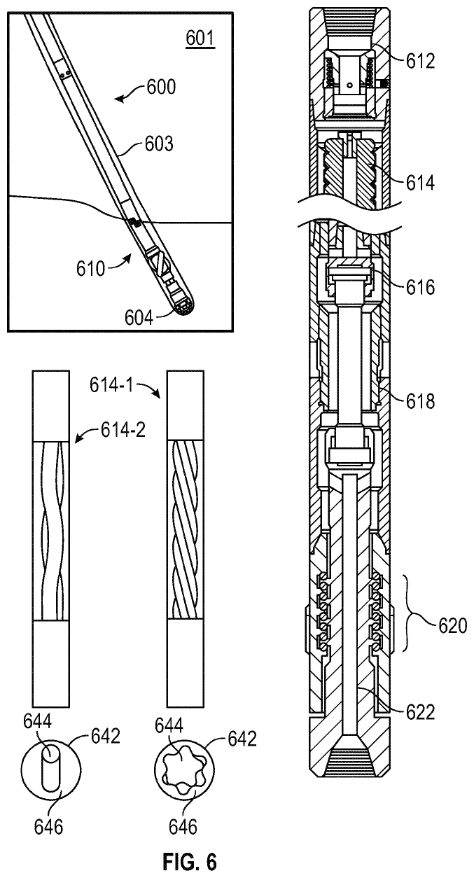

FIG. 6 shows an example of a drilling assembly 600 in a geologic environment 601 that includes a borehole 603 where the drilling assembly 600 (e.g., a drillstring) includes a bit 604 and a motor section 610 where the motor section 610 can drive the bit 604 (e.g., cause the bit 604 to rotate and deepen the borehole 603).

As shown, the motor section 600 includes a dump valve 612, a power section 614, a surface-adjustable bent housing 616, a transmission assembly 618, a bearing section 620 and a drive shaft 622, which can be operatively coupled to a bit such as the bit 604.

As to the power section 614, two examples are illustrated as a power section 614-1 and a power section 614-2 each of which includes a housing 642, a rotor 644 and a stator 646. The rotor 644 and the stator 646 can be characterized by a ratio. For example, the power section 614-1 can be a 5:6 ratio and the power section 614-2 can be a 1:2 ratio, which, as seen in cross-sectional views, can involve lobes (e.g., a rotor/stator lobe configuration). The motor section 610 of FIG. 6 may be a POWERPAK family motor section (Schlumberger Limited, Houston, Texas) or another type of motor section. The POWERPAK family of motor sections can include ratios of 1:2, 2:3, 3:4, 4:5, 5:6 and 7:8 with corresponding lobe configurations. As to the 1:2 ratio, it may be referred to as a one-to-two lobe ratio pump or, for example, a single lobe pump.

A power section can convert hydraulic energy from drilling fluid into mechanical power to turn a bit. For example, consider the reverse application of the Moineau pump principle. During operation, drilling fluid can be pumped into a power section at a pressure that causes the rotor to rotate within the stator where the rotational force is transmitted through a transmission shaft and drive shaft to a bit.

A motor section may be manufactured in part of corrosion-resistant stainless steel where a thin layer of chrome plating may be present to reduce friction and abrasion. As an example, tungsten carbide may be utilized to coat a rotor, for example, to reduce abrasion wear and corrosion damage. As to a stator, it can be formed of a steel tube, which may be a housing (see, e.g., the housing 642) with an elastomeric material that lines the bore of the steel tube to define a stator. An elastomeric material may be referred to as a liner or, when assembled with the tube or housing, may be referred to as a stator. As an example, an elastomeric material may be molded into the bore of a tube. An elastomeric material can be formulated to resist abrasion and hydrocarbon induced deterioration. Various types of elastomeric materials may be utilized in a power section and some may be proprietary. Properties of an elastomeric material can be tailored for particular types of operations, which may consider factors such as temperature, speed, rotor type, type of drilling fluid, etc. Rotors and stators can be characterized by helical profiles, for example, by spirals and/or lobes. A rotor can have one less fewer spiral or lobe than a stator (see, e.g., the cross-sectional views in FIG. 6).

During operation, the rotor and stator can form a continuous seal at their contact points along a straight line, which produces a number of independent cavities. As fluid is forced through these progressive cavities, it causes the rotor to rotate inside the stator. The movement of the rotor inside the stator is referred to as nutation. For each nutation cycle, the rotor rotates by a distance of one lobe width. The rotor nutates each lobe in the stator to complete one revolution of the bit box. For example, a motor section with a 7:8 rotor/stator lobe configuration and a speed of 100 RPM at the bit box will have a nutation speed of 700 cycles per minute. Generally, torque output increases with the number of lobes, which corresponds to a slower speed. Torque also depends on the number of stages where a stage is a complete spiral of a stator helix. Power is defined as speed times torque; however, a greater number of lobes in a motor does not necessarily mean that the motor produces more power. Motors with more lobes tend to be less efficient because the seal area between the rotor and the stator increases with the number of lobes.

The difference between the size of a rotor mean diameter (e.g., valley to lobe peak measurement) and the stator minor diameter (lobe peak to lobe peak) is defined as the rotor/stator interference fit. Various motors are assembled with a rotor sized to be larger than a stator internal bore under planned downhole conditions, which can produce a strong positive interference seal that is referred to as a positive fit. Where higher downhole temperatures are expected, a positive fit can be reduced during motor assembly to allow for swelling of an elastomeric material that forms the stator (e.g., stator liner). Mud weight and vertical depth can be considered as they can influence the hydrostatic pressure on the stator liner. A computational framework such as, for example, the POWERFIT framework (Schlumberger Limited, Houston, Texas), may be utilized to calculate a desired interference fit.

As to some examples of elastomeric materials, consider nitrile rubber, which tends to be rated to approximately 138 C (280 F), and highly saturated nitrile, which may be formulated to resist chemical attack and be rated to approximately 177 C (350 F).

The spiral stage length of a stator is defined as the axial length for one lobe in the stator to rotate 360 degrees along its helical path around the body of the stator. The stage length of a rotor differs from that of a stator as a rotor has a shorter stage length than its corresponding stator. More stages can increase the number of fluid cavities in a power section, which can result in a greater total pressure drop. Under the same differential pressure conditions, the power section with more stages tends to maintain speed better as there tends to be less pressure drop per stage and hence less leakage.

Drilling fluid temperature, which may be referred to as mud temperature or mud fluid temperature, can be a factor in determining an amount of interference in assembling a stator and a rotor of a power section. As to interference, greater interference can result in a stator experiencing higher shearing stresses, which can cause fatigue damage. Fatigue can lead to premature chunking failure of a stator liner. As an example, chlorides or other such halides may cause damage to a power section. For example, such halides may damage a rotor through corrosion where a rough edged rotor can cut into a stator liner (e.g., cutting the top off an elastomeric liner). Such cuts can reduce effectiveness of a rotor/stator seal and may cause a motor to stall (e.g., chunking the stator) at a low differential pressure. For oil-based mud (OBM) with supersaturated water phases and for salt muds, a coated rotor can be beneficial.

As to differential pressure, it is defined as the difference between the on-bottom and off-bottom drilling pressure, which is generated by the rotor/stator section (power section) of a motor. As mentioned, for a larger pressure difference, there tends to be higher torque output and lower shaft speed. A motor that is run with differential pressures greater than recommended can be more prone to premature chunking. Such chunking may follow a spiral path or be uniform through the stator liner. A life of a power section can depend on factors that can lead to chunking (e.g., damage to a stator), which may depend on characteristics of a rotor (e.g., surface characteristics, etc.).

As to trajectory of a wellbore to be drilled, it can be defined in part by one or more dogleg severities (DLSs). Rotating a motor in high DLS interval of a well can increase risk of damage to a stator. For example, the geometry of a wellbore can cause a motor section to bend and flex. A power section stator can be relatively more flexible that other parts of a motor. Where the stator housing bends, the elastomeric liner can be biased or pushed upon by the housing, which can result in force being applied by the elastomeric liner to the rotor. Such force can lead to excessive compression on the stator lobes and cause chunking.

A motor can have a power curve. A test can be performed using a dynamo meter in a laboratory, for example, using water at room temperature to determine a relationship between input, which is flow rate and differential pressure, to power output, in the form of RPM and torque. Such information can be available in a motor handbook. However, what is actually happening downhole can be differ due to various factors. For example, due to effect of downhole pressure and temperature, output can be reduced (e.g., the motor power output). Such a reduction may lead one to conclude that a motor is not performing. In response, a driller may keep pushing such that the pressure becomes too high, which can damage elastomeric material due to stalling (e.g., damage a stator).

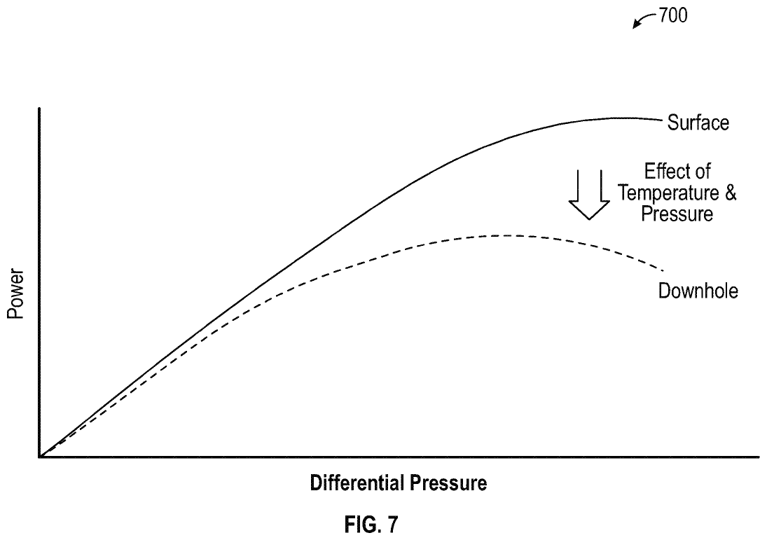

FIG. 7 shows an example of a plot 700 of power versus differential pressure for surface and downhole conditions. As shown, power can be reduced downhole due to effects of temperature and pressure and/or one or more other factors. The plot 700 shows power versus differential pressure where differences between surface and downhole may increase with higher differential pressures.

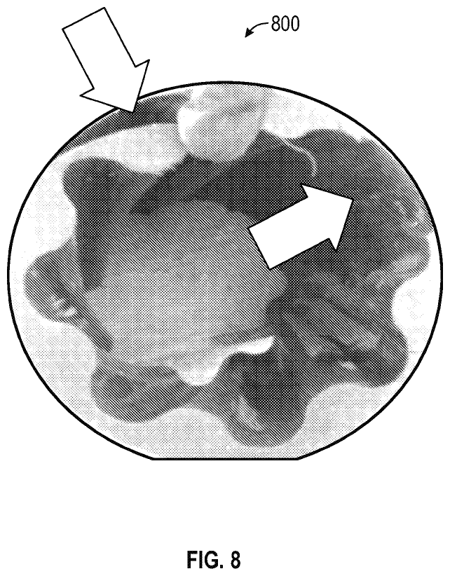

FIG. 8 shows an example of a photograph 800 that illustrates fatigue failure as to an elastomeric material of a stator of a motor. Arrows indicate where separation from a tube or housing has occurred and where chunking has occurred. In the example of FIG. 8, the stator is for a pump akin to the power section 614-1, rather than the power section 614-2. As explained, the power section 614-2 corresponds to a 1:2 ratio pump, which may be referred to as a one-to-two lobe pump.

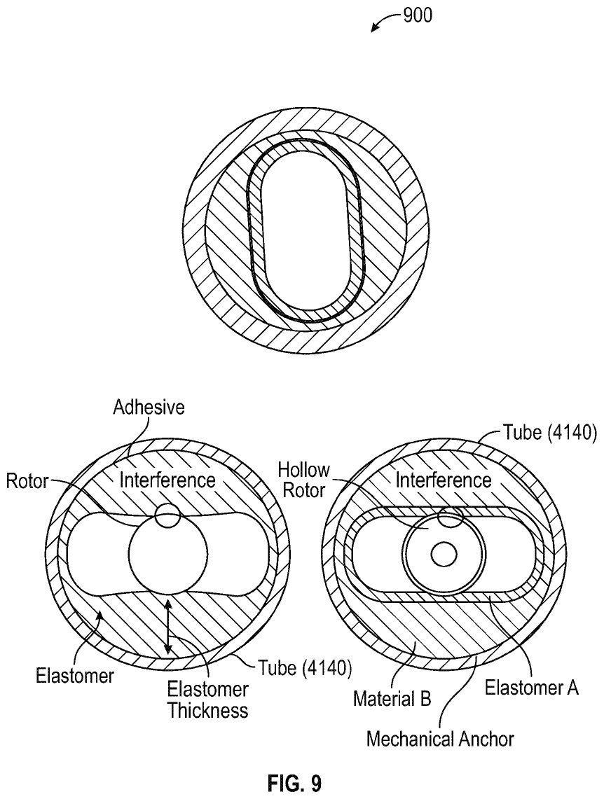

FIG. 9 shows examples of PCP components, including synthetic and/or natural materials, which can include polymeric materials, metals, composite materials, etc.

As an example, in various pumps, construction may use one or more compatabilizing layers, which may provide for enhanced adhesion and/or one or more other benefits.

As explained, ESPs are versatile and adaptable for use in various applications (e.g., artificial lift, injection, etc.). As explained, an ESP can include a series of centrifugal pump stages contained within a protective housing mated to a submersible electric motor. It is installed at the end of the production tubing; an armor-protected cable connects the pump to electric power and surface controls.

By controlling motor speed from surface, operators can vary production flow rate, for example, from 16 to 4,770 m3/d [100 to 30,000 bbl/d]. An ESP tends to be appropriate for moderate-to-high-production rate wells, including highly deviated wells and remote, subsea deep-water wells. As production rates fall, the pump motor can be slowed to accommodate, without an expensive well intervention.

While ESPs can be used for a wide range of flow rates, each specific system may be designed for a specific well; namely a tight range of pumping rates. As the well pressure and volume taper off, the pump begins to operate outside the specified range for the ESP originally installed. This can result in reductions in system efficiencies which can lead to mechanical problems, excessive energy costs, and premature system failure. When the efficiency of the pump has been reduced, inevitably, the operator will transition to a low flow solution such as a sucker rod pump or similar system which can accommodate the lower production volumes. However, these are often limited in effectiveness now that many ESPs are deployed in unconventional deviated wells many of which are even horizontal wells. Consequently, operators are often left without effective means of production alternatives and rely on cost intensive solutions which accelerate the aging of the equipment such as cycling the ESP on and off.

A complementary option to the ESP is an electrical submersible progressive cavity pump (ESPCP). When ESP efficiency drops off, migrating to an ESPCP may be a relatively seamless way to continue efficient production. An ESPCP may be a fully submersible pumping system. While various types of PCP may utilize a motor and gearbox to remain at the surface and the rotor to be driven from the surface by attaching to a long shaft, the ESPCP has a motor and gearbox attached to the pump fully submersed in the well and driven by an electrical power cord. As such, an ESPCP can be a drop-in replacement for the ESP and may utilize the same surface equipment. This reduces the work over cost as well as providing an effective alternative for unconventional deviated and horizontal wells.

As explained, in various types of pumps, one or more stator components may be sources of issues. As an example, a stator may be an injectable elastomer that the rotor moves against. Over time, the elastomer may degrade and/or swell from exposure to the downhole environment. In some instances, for PCP applications, stator deterioration is managed by swapping rotors at the surface. However, with an ESPCP fully submerged, the stator must survive the harsh conditions for generally a longer time than PCP stators can manage in order to make a system a more viable alternative for the low flow unconventional applications.

In various examples of system, such as one or more of those mentioned above, a technique and materials can be employed for bonding of elastomer to a rigid support structure which in the case of the composite PCP may be a thermoset material. Various PCPs utilize one or more of various types of solvent based adhesives such as MEGUM, CHEMLOK, or THIXON to bond the elastomer to the housing. These types of adhesives use highly reactive functional groups to promote interaction between the desired layers to be bonded. However, the reactive functionality that gives theses adhesives strong initial bonding also may predispose them to degradation in a hot/wet downhole environment. The reactive chemistries frequently utilized in solvent based adhesives include isocyanates, phenol/formaldehyde systems, cyanoacrylates, acrylated molecules, chlorinated polymers, and other reactive, typically polar materials that may generate strong adhesive bonds but are subject to hydrolytic degradation and thermal breakdown over time in the downhole environment. When compared to the fluid resistance and thermal stability of typical stator elastomer and structural thermoset elements, the adhesive material very quickly and obviously becomes the limiting factor. By utilizing a compatabilizing elastomer based tie-layer, a more robust bonding of the elastomer and thermoset can be generated through covalent bonding of each material; chemically crosslinking the elastomer to a thermoset. As such the limiting factor to the bond may be transferred to mechanical and chemical stability of the elastomer or thermoset and no longer a third material susceptible to adhesive failure from aging.

As mentioned, a method can use of a compatabilizing elastomer based adhesion promotor that facilitates covalent bonding of a primary stator elastomer to a rigid support structure which in the case of a composite PCP tends to be a thermoset material. Such an approach can generate a more fully bonded stator elastomer to structural thermoset system by incorporating a compatabilizing tie-layer that, for example, incorporates elements of both an elastomer and a thermoset material, enabling it to complete covalent bonding reactions with both. By avoiding the use of a solvent based adhesive system and utilizing a compatabilizing hybrid material, also known as a tie layer, a more robust bonding of the elastomer and thermoset can be generated through covalent bonding of each material; chemically crosslinking the elastomer to the thermoset. As such a limiting factor to the bond can now be transferred to mechanical and chemical stability of the elastomer or thermoset and no longer a third material susceptible to adhesive failure from aging. As an example, a stator of a pump may include one or more tie layers.

As explained, geometry of a standard PCP stator can makes it inherently a source of elastomer inconsistencies. The shape profile can describe an eccentric displacement that results in uneven sections of elastomeric material. A thick uneven elastomer wall can exhibit several drawbacks that can result in it being a primary source for failure down hole.

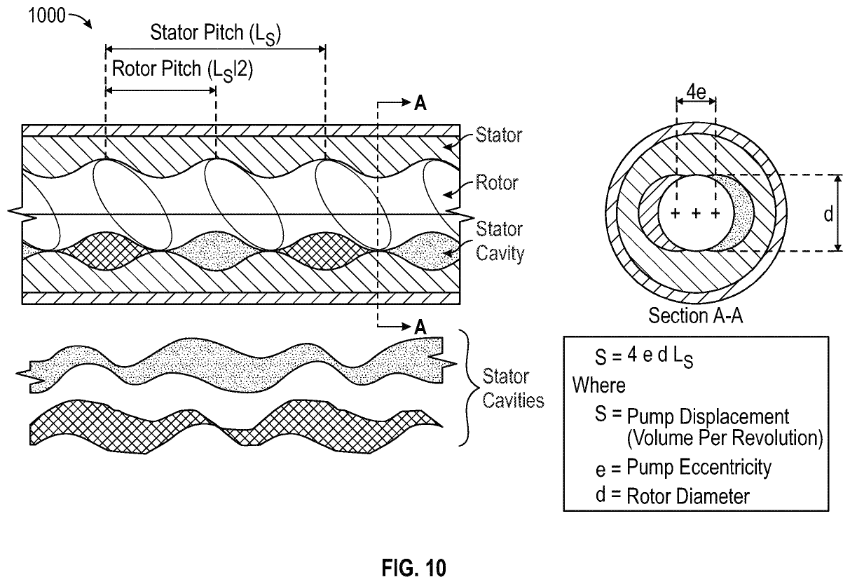

FIG. 10 shows an example of a PCP 1000 with various types and ranges of motions that can impact various components, particularly when exposed to downhole conditions. Specifically, there can be swell of elastomer where, because the wall is uneven, when exposed to downhole fluid and gas, the stator elastomer can swell unevenly, resulting in stator fit mismatch that can result in reduced pumping efficiency and damage to the elastomer. Further, as to heat dissipation, elastomeric materials tend to be inherently good thermal insulators. As a result, heat generated from the dynamic oscillation of the elastomer wall can buildup in the thick elastomer portions and eventually lead to thermal degradation of the elastomer.

As an example, a stator of a PCP or a positive displacement motor (PDM) can include a relatively thin, non-uniform elastomer lining. For example, an elastomer lining can include one or more features that make it non-uniform. Such an approach can help to improve the reliability of PCPs, for example, designed as 1:2 lobe ratio or a 1-to-2 rotor/stator lobe mechanism (also known as a single lobe design) based on a principle of encapsulation formulated by Rene Moineau (e.g., a Moineau pump). Such a pump can be implemented in different industries including artificial left in the oil and gas industry.

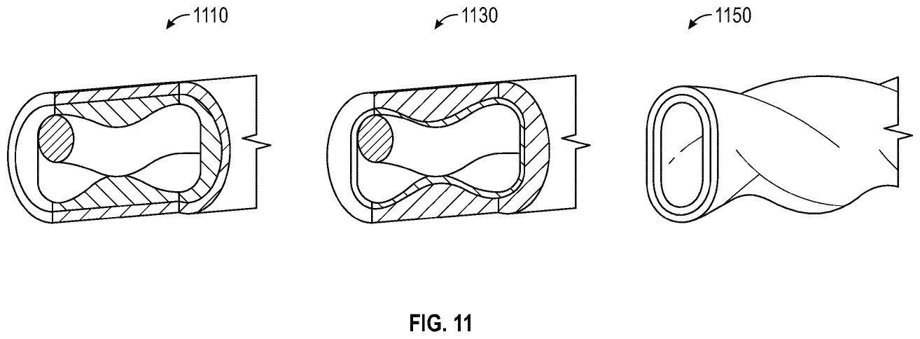

FIG. 11 shows an example of a PCP stator 1110 assembled with a conventional PCP rotor, an example of a uniform thin-wall PCP stator 1120 assembled with a conventional PCP rotor, and an example of a uniform thin-wall PCP stator 1130.

A stator for a 1-to-2 lobe PCP mechanism may be designed in two different ways. For example, consider a PCP structure that includes a conventional stator where a rubber lining is firmly adhered to a simple cylindrical tube that may be made of a carbon steel. In this case the thickness of rubber lining is very non-uniform (see, e.g., the stator 1110) and the rubber/steel interface is a simple cylinder “mimicking” a stator tube inner diameter (ID). Another PCP design includes a stator where a rubber lining is made as a uniform feature (see, e.g., the stators 1120 and 1130). As to the stators 1120 and 1130, the stator/rotor interacting geometry remains the same as for the stator 1110; however, the rubber/steel interface is substantially different; it forms a quite specific helical shape which could be considered as the uniform offsetting of the rubber internal geometry towards the stator tube outer diameter (OD).

As explained, for the stators 1120 and 1130, the rubber/steel interfaces can be identical, where a difference between those two stators pertains to the geometry of tube OD. Tube OD can be selected based on various pros and cons as to one or more scenarios.

As an example, a stator can include an elastomeric lining that is relatively thin where elastomer thickness is distributed non-uniformly.

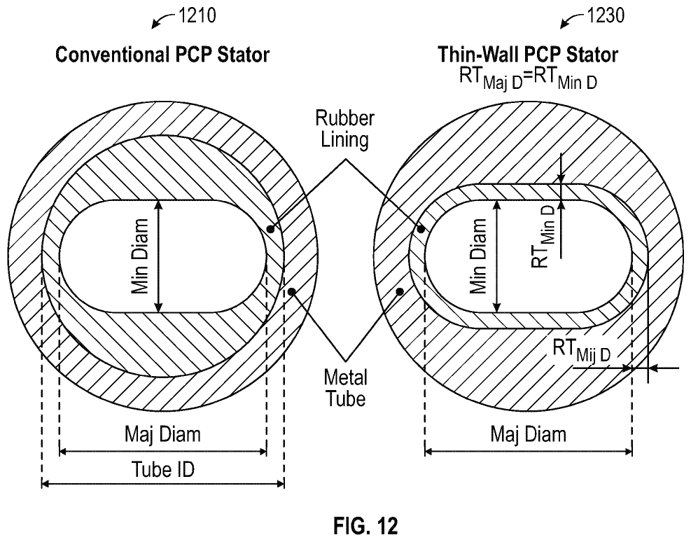

FIG. 12 shows an example of a conventional PCP stator 1210 and an example of a thin-wall PCP stator 1230. FIG. 12 shows various dimensions, including: Min Diam as the stator minor diameter, Maj Diam as the stator major diameter, RT_{Min D} as the rubber thickness on the stator minor diameter, and RT_{Maj D} as the rubber thickness on the stator major diameter.

As shown in FIG. 12, the stators 1210 and 1230 can each have an inner perimeter defined by a stadium, also called a discorectangle, obround, or sausage body, which is a geometric figure consisting of a rectangle with top and bottom lengths denoted “a” whose ends are capped off with semicircles of radius “r”. In the example stator 1210, an outer perimeter is a circle; whereas, for the example stator 1230, an outer perimeter is also a stadium. As shown for the example stator 1230, two stadiums can be coincident along a common central axis to form a uniform thickness therebetween.

To compare the two example variants 1210 and 1230 the following parameters may be assessed: performing factors (e.g., pumping capacity versus diff pressure and torque versus diff pressure); stress in rubber lining; strain in rubber lining; and heat dissipation through rubber lining.

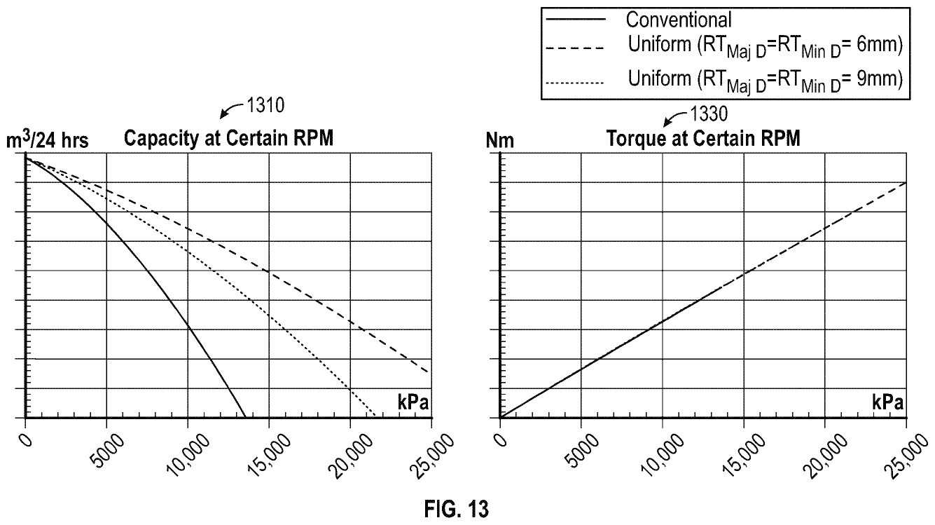

FIG. 13 shows example plots 1310 and 1330 for convention and uniform stators for capacity in volume per 24 hours (m³/24 h) versus differential pressure (kPa) and torque (Nm) versus differential pressure (kPa), respectively, for a particular rotor speed (RPM). The plots 1310 and 1330 indicate substantial differences in performance attributed to conventional and thin-wall stators. As indicated, with thinner rubber thickness, a pump has better capacity and efficiency; noting that the same trend applies for torque. Pumps with thinner rubber lining tend to be capable to resist much higher torques in a comparison with conventional design. From this perspective, thin-wall pumps appear to be more beneficial.

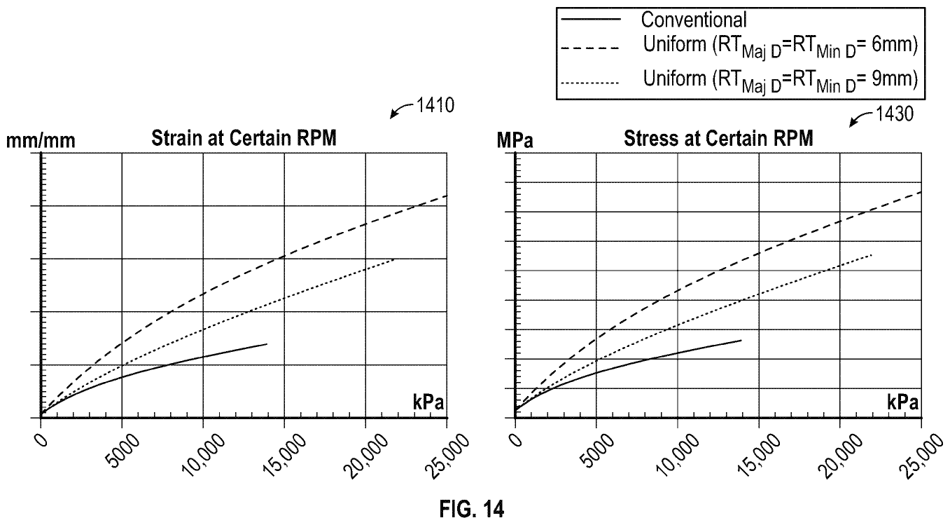

FIG. 14 shows example plots 1410 and 1430 as to strain (mm/mm) versus differential pressure (kPa) and stress (MPa) versus differential pressure (kPa), respectively, for a particular rotor speed (RPM). In terms of stress/strain levels in rubber linings, however, the situation is substantially different than for capacity and torque. As shown, a conventional stator undergoes lower strain/stress than a thin-wall stator at the same differential pressure. Thus, fatigue life for a thin-wall stator is expected to be shorter in a comparison with a conventional design.

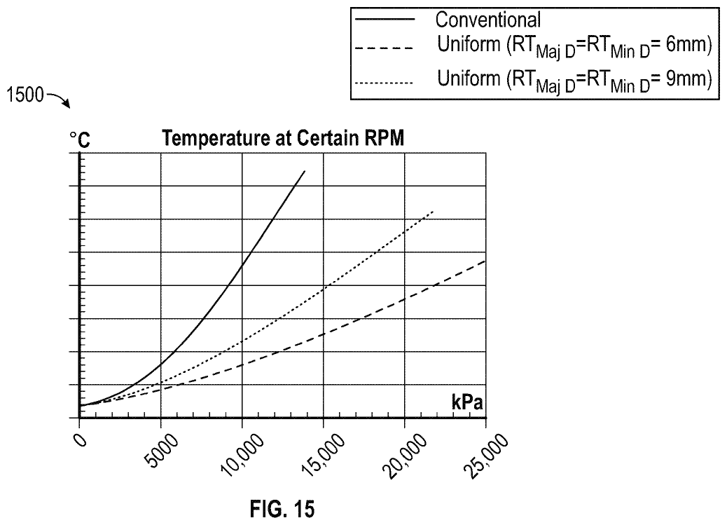

FIG. 15 shows an example plot 1500 for conventional and uniform thin-wall stators for temperature (degrees C) versus differential pressure (kPa). As shown, complexities can arise if temperature buildup inside a rubber lining is taken into account. As a conventional stator tends to have relatively thick portions of its rubber lining, those areas will be prone to overheating, for example, due to a hysteresis effect which is part of elastomer hyper-elastic properties. Thus, the higher pump RPM (rotary speed), the higher temperature buildup degree will be observed.

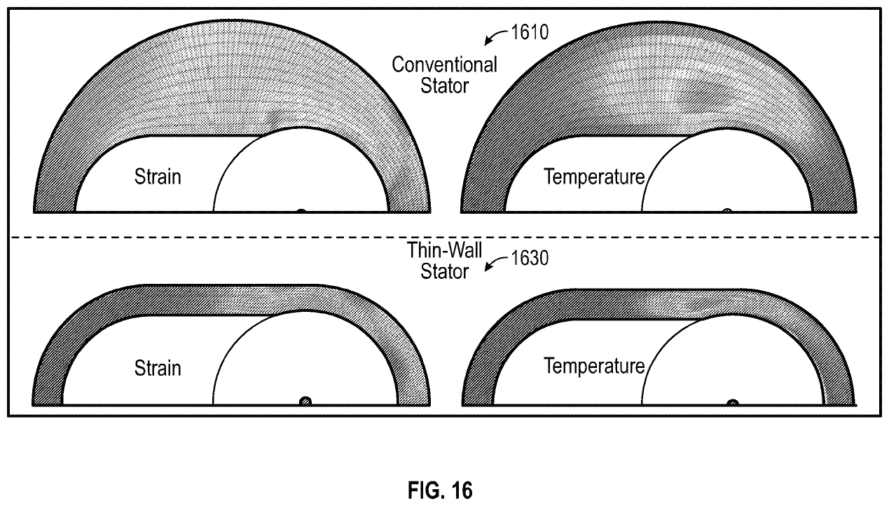

FIG. 16 shows example plots 1610 and 1630 for a conventional stator and a thin-wall stator from finite element analysis (FEA) for strain and temperature. As shown, maxima in strain may be localized proximate to a boundary where temperature may build interiorly, between boundaries. An increase in temperature and sustained elevated temperature can depend on various factors. In particular, an ability to dissipate heat generated internally can be a factor, which can depend on material properties, shape and size.

As an example, a stator or pump geometry can be balanced for improved performance with acceptable strain/stress levels inside an elastomeric lining and acceptable rate of heat dissipation through the elastomeric lining. In such an example, the stator or pump geometry can include a 1-to-2 lobe geometry (e.g., a 1:2 ratio Moineau pump).

As mentioned, a stator or pump can be designed for improved reliability where the stator or pump uses a one-to-two lobe PCP/PDM mechanism. In such an approach, improvement can be by introducing an unevenly distributed thickness in a stator elastomer lining. For example, consider one or more of the following approaches: (1) rubber thickness on the stator major diameter can be greater than the thickness on stator minor diameter, and a curve connecting stator major and minor diameters on the rubber/metal interface can be characterized by a generally convex shape; (2A) rubber thickness on the stator major diameter can be close to the thickness on stator minor diameter, and a curve connecting stator major and minor diameters on the rubber/metal interface can be characterized by a set of convex and concave splines; and (2B) rubber thickness on the stator major diameter can be greater than the thickness on stator minor diameter, and a curve connecting stator major and minor diameters on the rubber/metal interface can be characterized by a set of convex and concave splines.

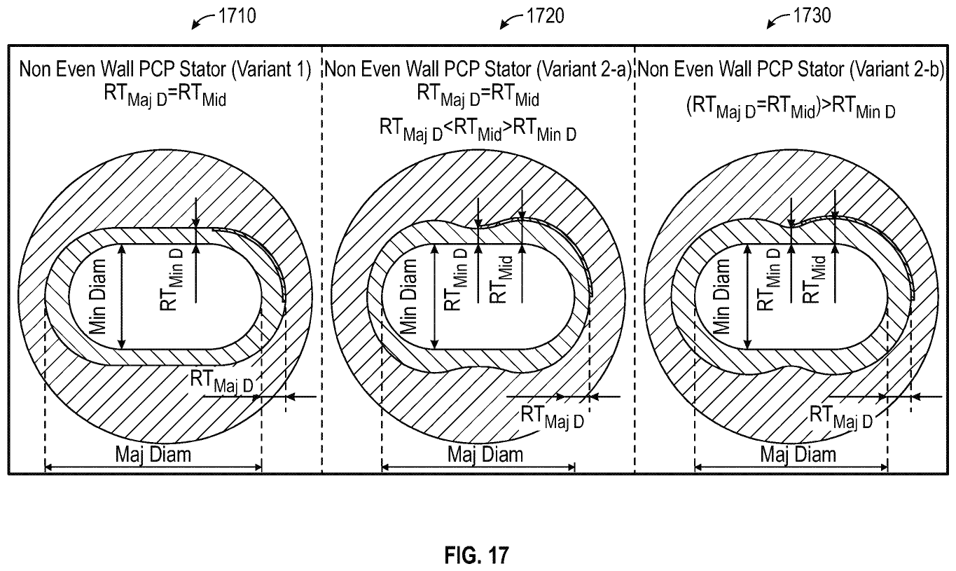

FIG. 17 shows example stators 1710, 1720 and 1730 where the stator 1710 corresponds to (1), above, and where the stators 1720 and 1730 correspond to (2A) and (2B), above. As shown in the examples of FIG. 17, as to the stator 1710, RT_{Maj D} can be greater than RT_{Min D}; as to the stator 1720, RT_{Maj D} can be approximately equal to RT_{Min D} where a parameter RT_{Mid} can be greater than RT_{Maj D} and greater than RT_{Min D}; and, as to the stator 1730, RT_{Maj D} can be approximately equal to RT_{Mid} where both can be greater than RT_{Min D}.

As shown in FIG. 17, the stators 1710, 1720 and 1730 can each have an inner perimeter defined by a stadium, also called a discorectangle, obround, or sausage body, which is a geometric figure consisting of a rectangle with top and bottom lengths denoted “a” whose ends are capped off with semicircles of radius “r”. However, in contrast to the example stator 1230 of FIG. 12, an outer perimeter is not a stadium that can define a uniform thickness with respect to the inner perimeter. Hence, in the examples of FIG. 17, the stators 1710, 1720 and 1730 are thin-wall stators with non-uniform thickness. As to the stator 1710, the outer perimeter may be a stadium, however, with a different length (e.g., long side of a rectangle length). As shown in the example of FIG. 17, the stator 1710 can have an outer perimeter that differs from a stadium in that rather than semicircular ends, the ends can be semielliptical or, for example, of another shape.

As to shown in FIG. 17, as to the stator 1710, a part of an ellipse (see, e.g., yellow spline) can used to form a thicker rubber layer on the stator major diameter; noting that one or more other shapes may be utilized (e.g. curves, etc.). For such a transition curve, one or more of various geometric, parametric, etc., shapes may be utilized. For example, consider one or more of ovals, part of a sinusoid, a parabolic line, etc. As to the stators 1720 and 1730, one or more of such curves may be utilized, for example, in combination with one or more other curves. For example, as to the stator 1720, to build a rubber/metal interface, three curves tangentially aligned to each can be used: part of ellipse (yellow line); a convex arc (green line); and a concave arc (blue line). As to the example stator 1730, two curves tangentially aligned to each other can be used: a convex arc (yellow line); and a concave arc (blue line).

The example stators 1710, 1720 and 1730 of FIG. 17 are non-uniform thin-wall variants that provide a set of benefits in terms of pump performance (e.g., capacity, torque curves), stress/strain levels inside rubber lining and temperature buildup.

As an example, a parametric curve may be utilized to define at least a portion of a stator. A parametric curve can be defined in part by continuity in terms of differentiability. For example, C0 continuity means that a curve is connected at joints, C1 continuity means that a curve is connected as segments that share a common first derivative at a joint, and Cn continuity means that segments share the same nth derivative at a joint. As an example, a profile may be represented by a parametric curve that has C0 continuity and/or greater than C0 continuity. For example, C0 continuity may exist at a transition between segments. A transition region may include a transition point, which may be a joint where two segments meet and where continuity may be defined (e.g., as being at least C0 continuity). As an example, a parametric curve may be utilized to define a profile, such as, for example, an outer profile of a portion of a stator (e.g., an elastomeric portion of a stator). As an example, another portion of a stator may include a matching profile. As an example, a tie-layer may be defined by one or more profiles where, for example, the tie-layer may impart non-uniform thickness. As an example, a tie-layer can include one or more elastomers and/or one or more entities that can provide for binding to an elastomer or elastomers.

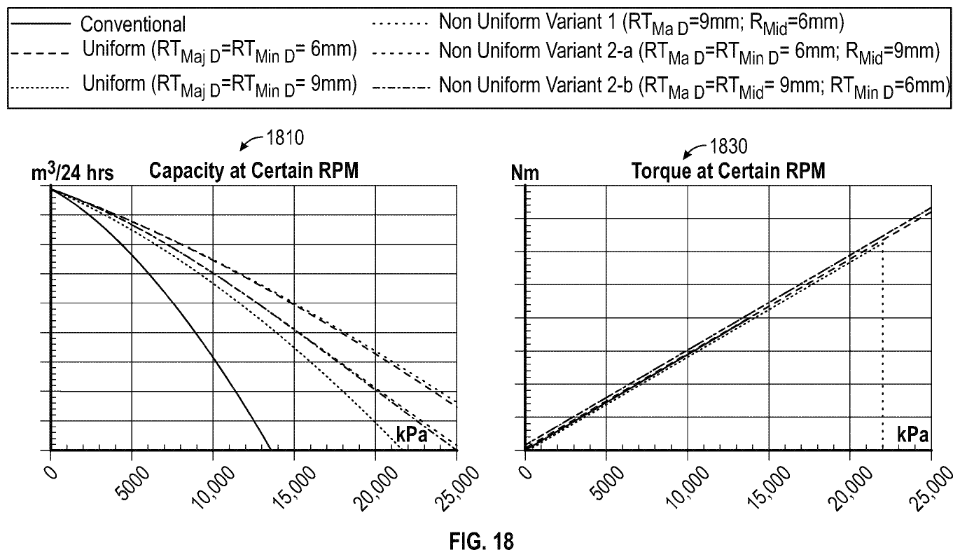

FIG. 18 shows example plots 1810 and 1830 for the three variants 1710, 1720 and 1730 in comparison to conventional and uniform thin-wall stators. In terms of pumping capacity and torque “ability”, the three non-uniform variants outperform the conventional pump and uniform thin-wall pump made with 9 mm rubber thickness. Pumping capacity for the stators 1720 and 1730 is slightly less in a comparison to the stator 1710, which performs similar to the uniform thin-wall pump made with a 6 mm uniform rubber lining.

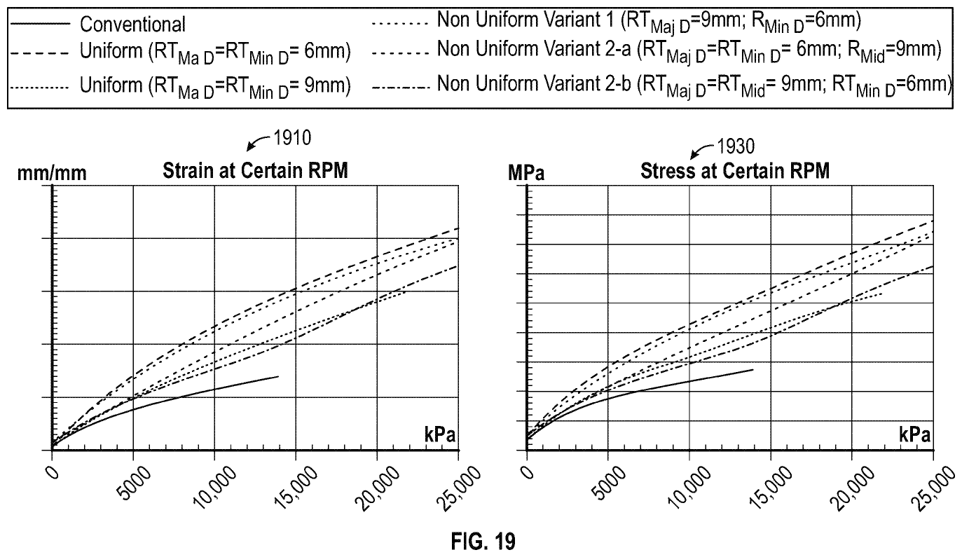

FIG. 19 shows example plots 1910 and 1930 to demonstrate that rubber is stressed to a lower degree for the three non-uniform variants 1710, 1720 and 1730 in comparison to the 6 mm uniform thin-wall option. In addition, the stator 1720 shows generally lower strain/stress levels inside rubber lining compared to the uniform thin-wall stator made with a 9 mm rubber thickness.

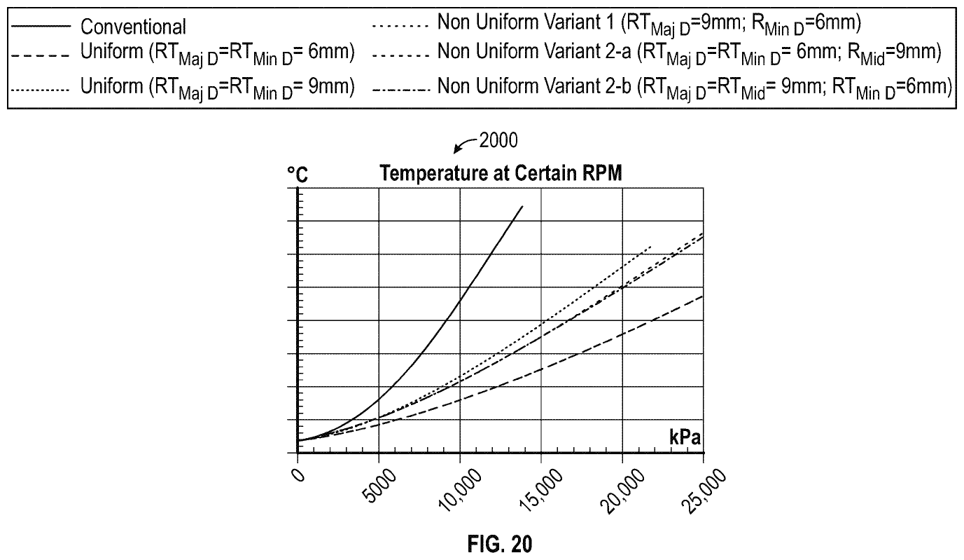

FIG. 20 shows an example plot 2000 of the three non-uniform variants 1710, 1720 and 1730 as being less prone to be overheated due to a temperature buildup in comparison to the conventional pump and the uniform thin-wall pump made with a 9 mm rubber thickness.

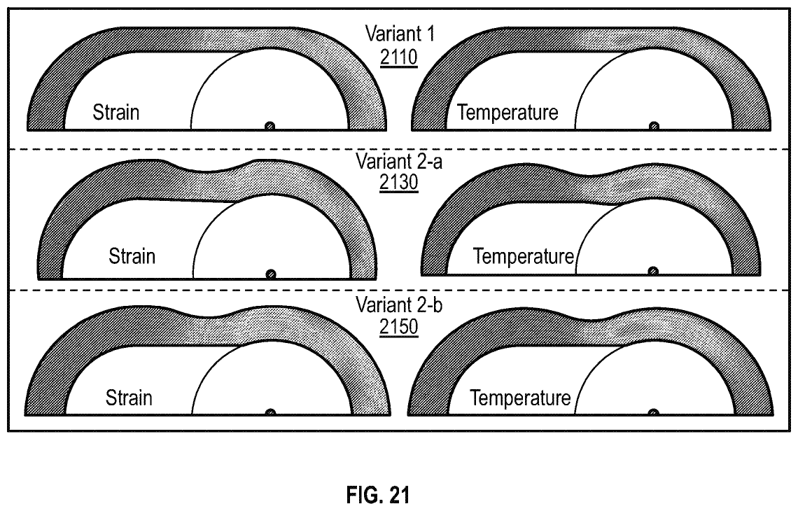

FIG. 21 shows example plots 2110, 2120 and 2130 for the stators 1710, 1720 and 1730, respectively. As shown, by varying the distribution of rubber thickness in a non-uniform stator lining, a balance can be achieved between pump performance and its reliability. Specifically, the plots 2110, 2120 and 2130 show FEA maps for strain and temperature distribution inside the three non-uniform elastomer linings of the stators 1710, 1720 and 1730.

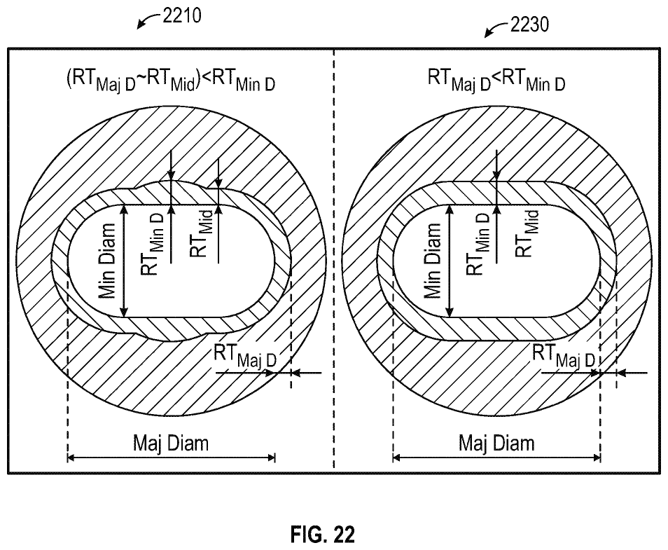

FIG. 22 shows example stators 2210 and 2230 with unevenly distributed rubber thickness; however, analysis of the stators 2210 and 2230 did not indicate a substantial improvement in stator reliability and/or performance.

As an example, a thickness may be made uneven via use of a tie-layer. For example, consider a tie-layer that can impart a particular shape that makes a stator uneven (e.g., varying) in its thickness. As an example, a stator can include a tie-layer adjacent to a thermoset resin and a rubber lining where the stator includes a metallic tube for a housing (e.g., exterior shell).

As to permanent bonding, often elastomers are bonded using an adhesive material, which “glues” the two layers together, typically resulting in mechanical bond combined with van der Waals forces. In the case of highly reactive adhesives, it is possible to form chemical covalent bonds to a surface. However, the reactive chemistries frequently used for these adhesives typically can be susceptible to chemical and thermal degradation at downhole conditions. Typically, for those materials to contain sufficient reactivity to act as an adhesive (e.g., low viscosity, high surface energy), the material is less robust to chemical attack and aging. As explained, a compatabilizing tie layer can include thermoset reactive functionality along with elastomer reactive functionality. Such an approach allows a tie-layer to co-cure with both an elastomer layer and a thermoset later, resulting in a covalently bonded system. By providing a custom formulated layer that integrates into both the structural thermoset and the elastomer, robust bonding can occur using the same high-performance materials each individual layer is utilizing.

As to aging, a tie-layer system may employ a common base chemistry and a common cure system as stator and thermoset regions to achieve desired bonding. Desirable properties for mechanical stability, chemical resistance, swell, embrittlement, softening, etc., can be imparted through use of a tie-layer system where they may no longer be weak points in the bonding of the layers.

As to bond facilitation, a tie-layer may be an additional layer that is a layer to facilitate bonding. For maximum resistance to the downhole fluids and gases that a pump may encounter, a primary rubber lining of an elastomer stator may be formulated using one or more elastomer materials with inherently low reactivity and high degree of saturation in the polymer backbone. As a result of this high saturation and low reactivity, elastomers based on these systems tend to be inherently difficult to bond. As an example, a tie-layer material may be an elastomer with properties that may be selected or otherwise tailored to be similar to a stator elastomer and, for example, with greater unsaturation in a polymer backbone. In such an approach, greater unsaturation enables bonding to be much easier and more complete with adhesives. As such an approach still utilizes an elastomer that can have similar properties to a primary stator elastomer, a method can include co-vulcanizing with a primary elastomer liner.

As to an example of a tie-layer, considering a composite PCP construction where the primary stator liner is HNBR and the structural thermoset composite is an epoxy resin system, an example tie-layer system may include an elastomer compound that contains (e.g., or is wholly comprised of) a co-functional system.

As an example, stator elastomers may include, but are not limited to, one or more of NBRs, HNBR aFKM and FEPM. As an example, a tie-layer material, if present, may be modified based on a stator elastomer in order to match a vulcanization system used in the elastomer. As an example, a tie-layer material may be modified to match a base resin and cure system of a structural thermoset.

As to some examples of thermosetting chemistries for high temperature bonding applications, these may be based on cyanoacrylate, acrylate, polyester, epoxy, benzoxazine, polyimide, bismaleimide, and/or cyanate ester chemistry. While robust in many uphole applications, these thermosets may be limited in chemical compatibility and high-temperature capability. For example, with high-temperature exposure with small amounts of water, these polymers may be susceptible to hydrolytic attack, which results in a depolymerization reaction of the material and subsequent loss of adhesion.

However, a range of resin chemistries for encapsulation are available. Such resin chemistries can offer low viscosity processing, high glass transition temperatures, excellent electrical/mechanical/thermal properties, and hydrolysis resistant chemistries. These materials can be formulated for the material to be used at temperatures up to 300 C (572 F).

As an example, a polymer may be a thermosetting polymer. As an example, a polymer may be a non-thermosetting polymer. As an example, a polymeric material may include a mixture of one or more thermosetting polymers and one or more non-thermosetting polymers. A US Patent Application Publication having Pub. No. US20210288541A1, published 16 Sep. 2021, is incorporated by reference herein in its entirety, and describes various types of polymers, pumps, etc.

As an example, a polymeric material may be or include an ethylene propylene diene monomer (M-class) rubber (EPDM), which is a type of synthetic rubber that is an elastomer. As an example, a polymeric material may be or include a nitrile butadiene rubber (NBR), which is a family of unsaturated copolymers of 2-propenenitrile and various butadiene monomers (1,2-butadiene and 1,3-butadiene). As an example, a polymeric material may be or include polyether ether ketone (PEEK), which is an organic thermoplastic polymer in the polyaryletherketone (PAEK) family. As an example, a polymeric material may be or include polyvinylidene fluoride, or polyvinylidene difluoride (PVDF), which is a thermoplastic fluoropolymer produced by the polymerization of vinylidene difluoride. The aforementioned EPDM, NBR (e.g., also consider HNBR), PEEK, PAEK and PVDF materials are given as some examples of types of polymers that may be in a polymeric material.

Epoxy resins, also known as polyepoxides are a class of reactive prepolymers and polymers which contain epoxide groups.

Maleimide and its derivatives can be prepared from maleic anhydride, for example, by treatment with amines followed by dehydration. A feature of the reactivity of maleimides is their susceptibility to additions across the double bond either by Michael additions or via Diels-Alder reactions. Bismaleimides are a class of compounds with two maleimide groups connected by the nitrogen atoms via a linker. Bismaleimides can be used as crosslinking reagents (e.g., in polymer chemistry).

Polybutadiene is a synthetic rubber that is a polymer that can be formed from the polymerization process of the monomer 1,3-butadiene.

Oxazines are heterocyclic compounds that include one oxygen atom and one nitrogen atom. Isomers exist depending on the relative position of the heteroatoms and relative position of the double bonds. Derivatives may also referred to as oxazines; examples include ifosfamide and morpholine (tetrahydro-1,4-oxazine).

Cyanate esters include an-OCN group. Cyanate esters can be cured and/or postcured by heating. As an example, curing may be alone at elevated temperatures or, for example, at lower temperatures in presence of a suitable catalyst. As an example, a catalyst may be a transition metal complex such as, for example, one that includes cobalt, copper, manganese and/or zinc. As an example, cyanate esters can be used to produce a thermoset material with a relatively high glass-transition temperature (Tg), for example, up to about 400 degrees C with a relatively low dielectric constant. A cyanate ester material may exhibit relatively low moisture uptake and a higher toughness compared to epoxies.

Silicones are polymers that include repeating units of siloxane. Silicones can be relatively heat-resistant and/or rubber-like, for example, consider examples such as silicone oil, silicone grease, silicone rubber, silicone resin, and silicone caulk.

Ring-opening metathesis polymerization (ROMP) is a type of olefin metathesis chain-growth polymerization. Reactions can be driven by relief of ring strain in cyclic olefins (e.g. norbornene, cyclopentene, etc.). A catalyst that may be used in a ROMP reaction can include a metal, for example, consider a RuCl₃/alcohol mixture, a catalyst, etc. As an example, a catalyst can be a transition metal carbene complex. For example, consider benzylidene-bis(tricyclohexylphosphine)-dichlororuthenium, [1,3-bis-(2,4,6-trimethylphenyl)-2-imidazolidinylidene]dichloro(phenylmethylene)(tricyclohexylphosphine)ruthenium, Dichloro(o-isopropoxyphenylmethylene)(tricyclohexylphosphine)ruthenium(II), and [1,3-Bis-(2,4,6-trimethylphenyl)-2-imidazolidinylidene]dichloro(o-isopropoxyphenylmethylene)ruthenium.

As an example, a polymer may be formed at least in part via ROMP. For example, as a prepolymer component amenable to forming a polymer via ROMP, consider a carbon backbone with functional groups that include at least one oxygen that provides an amount of hydrophilicity may be present along with a hydrocarbon chain (e.g., carbon backbone) that provides an amount of hydrophobicity where at least one functional group may be present on the hydrophobic hydrocarbon chain where such a functional group may participate in ROMP (e.g., via relief of ring stress). In such an example, the prepolymer component may be an ester such as a diester, a triester, etc. (e.g., an n-ester). As an example, consider a triester that includes at least one hydrocarbon chain with a functional group that includes a ring that is amenable to ROMP via relief of ring stress.

As mentioned, a ROMP process can employ a catalyst that can include a metal (e.g., Ru, etc.). As an example, a ROMP process may be utilized to form a copolymer (e.g., via two monomers, three monomers, etc.). For example, consider a scheme for forming a copolymer utilizing a functionalized triester as one of the monomers. As an example, DILULIN material (Cargill Inc., Minneapolis, MN) may be utilized, which is a mixture of norbornyl-functionalized linseed oil and cyclopentadiene (CPD) oligomers (e.g., one fraction consisting of modified linseed oil at about 70 percent by weight and another of cyclopentadiene (CPD) oligomers at about 30 percent by weight). In such an example, the norbornene groups are ROMP-reactive. In such a scheme, one or more additional materials can be included such as, for example, one or more of dicyclopentadiene (DCPD) and ethylidenenorbornene (ENB) (e.g., to form a copolymer, which may be a terpolymer, etc.). At room temperature, DCPD is a white crystalline solid. Norbornene is a bridged cyclic hydrocarbon that can be provided as a white solid. Norbornene includes a cyclohexene ring with a methylene bridge between C-3 and C-6; it carries a double bond which induces ring strain. ENB is a bicyclic monomer and intermediate that includes two double bonds, each with a different reactivity. ENB can be produced from vinyl norbornene, which can be made from butadiene and dicyclopentadiene DCPD.

As an example, a terpolymer may be a DCPD/ENB/DILULIN terpolymer (DED terpolymer). Synthesis of such a terpolymer may proceed at least in part via ROMP. For example, DED terpolymer can be cured via ROMP using transition metal chlorides (e.g., WCl₆, hexachloro tungsten) in combination with Lewis-acidic co-catalysts (e.g., EtAlCl₂, ethylaluminum dichloride). As an example, a DED terpolymer can also be cured with transition metal complexes (e.g. titanium, tungsten, molybdenum, ruthenium, osmium, etc.) with organic ligands. As an example, cationic polymerization can be accomplished using one or more cationic catalysts, such as, for example, one or more of BF₃·O(C₂H₅)₂ (boron trifluoride ethyl etherate), B(C₆F₅)₃ (tris (pentafluorophenyl) borane), MAO (methylalumoxane), VCl₄ (tetrachlorovanadium), and AlBr₃ (tribromoalumane).

While a terpolymer is mentioned as an example of a copolymer, in general, one or more types of copolymers may be synthesized. For example, consider a DCPD/DILULIN copolymer (DD copolymer) or an ENB/DILULIN copolymer (ED copolymer).

As mentioned, a copolymer thermosets can be synthesized from DCPD and/or ENB as well as a functionalized oil (e.g., as in the DILULIN material, etc.). Such synthesis can include ring opening metathesis polymerization (ROMP), which may employ a catalyst or catalysts (e.g., 2nd generation Grubbs' catalyst, etc.). The DILULIN material includes norbornyl-functionalized linseed oil synthesized by Diels-Alder reaction of linseed oil and DCPD at high temperatures and pressures. The DILULIN oil component, a triester, has an average of less than one bicyclic moiety per triglyceride. The low reactivity of the DILULIN material due to the low number of bicyclic moiety compared to DCPD and ENB can decrease curing kinetics, which can, for example, provide time for one or more filling and/or impregnation process (e.g., before gelation, a transition from liquid to solid). As an example, the relatively low viscosity of DCPD and/or ENB may be controlled by adding different concentrations of the DILULIN material.

As an example, a terpolymer or other copolymer formed via use of a functionalized n-ester and ROMP, may exhibit toughness and adhesion (e.g., via presence of the n-ester structure).

As an example, a copolymer formed at least in part from a functionalized n-ester. For example, the aforementioned DED copolymer thermoset may be utilized. Such DED copolymer thermosets have relatively high toughness at relatively high temperature and pressure, which may extend service time. As an example, due to the relatively low viscosity and ability to manipulate processability and thermal conductivity, a copolymer based at least in part on a functionalized n-ester may be useful as, for example, a potting material, an encapsulation material, etc., particularly for relatively extreme environments.

As an example, a copolymer material formed at least in part from a functionalized n-ester and ROMP can be utilized where high Tg, high toughness thermoset resins with a very low curing temperature are presently used. As an example, such a copolymer material may replace one or more of phenolic and epoxy materials (e.g., while providing improved properties and processability).

A pre-ceramic polymer can be a polymer that can be heated to elevated temperature or pyrolyzed to form a ceramic material. For example, consider polycarbosilanes, with a carbon-silicon backbone, that produce silicon carbide on pyrolysis and polysiloxanes, with a silicon-oxygen backbone, that produce silicon oxycarbides on pyrolysis.

As an example, a polymer composite material can include a polymer matrix that is an organic or inorganic polymer matrix (e.g., one or more of epoxy, bismaleimide, polybutadiene, benzoxazine, cyanate ester, silicone, Ring-Opening Metathesis Polymers (ROMP), preceramic polymers) or a mixture thereof.

As an example, a polymer composite material can be cured by application of heat and can be used as either a solvent free system or dispersed in solvent to aid in viscosity reduction. As an example, a polymer composite can be obtained through use of a polymer matrix filled with particulate filler. As an example, particulate filler can include one or more of aluminum oxide, aluminum nitride, boron nitride, silicon nitride, and beryllium oxide.

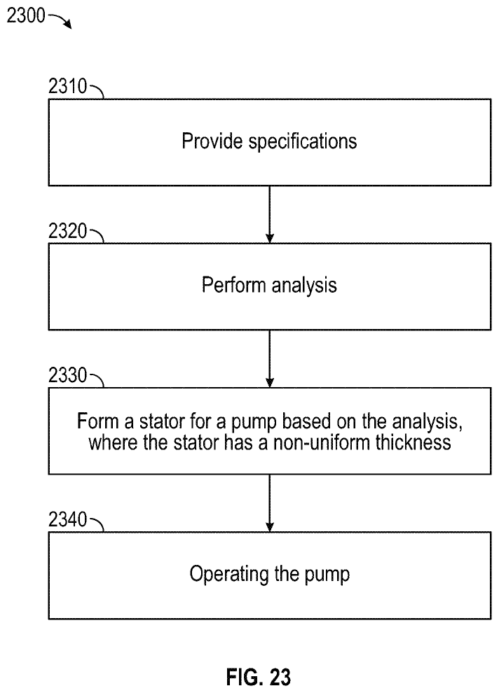

FIG. 23 shows an example of a method 2300 that includes a provision block 2310 for providing specifications; a performance block 2320 for performing an analysis; a formation block 2330 for forming a stator for a pump based on the analysis, where the stator has a non-uniform thickness; and an operation block 2340 for operating the pump.

As an example, a fluid displacement pump can include a rotor; and a stator, where the stator includes an elastomeric material with a non-uniform thickness, and where the rotor and the stator have a one-to-two lobe ratio. In such an example, the elastomeric material can include an inner profile and an outer profile, where the non-uniform thickness is characterized by a varying radial thickness measured between the inner profile and the outer profile.

As an example, an elastomeric material can include an inner profile and an outer profile, where the non-uniform thickness is characterized by the inner profile being a stadium and the outer profile not being a stadium. In such an example, the outer profile may be defined by a rectangle having opposing ends that are semielliptical. In such an example, the semielliptical ends can be defined by a minor axis that is equal to a distance between opposing sides of the rectangle and a semi-major axis.

As an example, an elastomeric material can include a major diameter, a minor diameter, a radial thickness along the major diameter and a radial thickness along the minor diameter, where the radial thickness along the major diameter is greater than the radial thickness along the minor diameter (see, e.g., the example stator 1710 of FIG. 17). As an example, an elastomeric material can include a major diameter, a minor diameter, a radial thickness along the major diameter, a radial thickness along the minor diameter, and a radial thickness between the major diameter and the minor diameter that is greater than the radial thickness along the major diameter and that is greater than the radial thickness along the minor diameter (see, e.g., the example stator 1720 of FIG. 17). As an example, an elastomeric material can include a major diameter, a minor diameter, a radial thickness along the major diameter, a radial thickness between the major diameter and the minor diameter, and a radial thickness along the minor diameter that is less than the radial thickness along the major diameter and that is less than the radial thickness between the major diameter and the minor diameter (see, e.g., the example stator 1730 of FIG. 17).

As an example, a stator can include a metal tube where an elastomeric material is disposed within the metal tube. In such an example, the stator can include a filler material that is disposed between an outer perimeter of the elastomeric material and an inner perimeter of the metal tube. In such an example, the elastomeric material can include or be adjacent to a tie-layer that binds the elastomeric material to the filler material. In such an example, the tie-layer can generate at least a portion of non-uniformity of a non-uniform thickness.

As an example, a fluid displacement pump can include: a rotor; a stator, where the stator includes an elastomeric material with a non-uniform thickness, and where the rotor and the stator have a one-to-two lobe ratio; and a motor operatively coupled to a rotor. As an example, a fluid displacement pump can include a fluid inlet and a fluid outlet. In such an example, a rotor can be driven by fluid flowing from the fluid inlet to the fluid outlet.

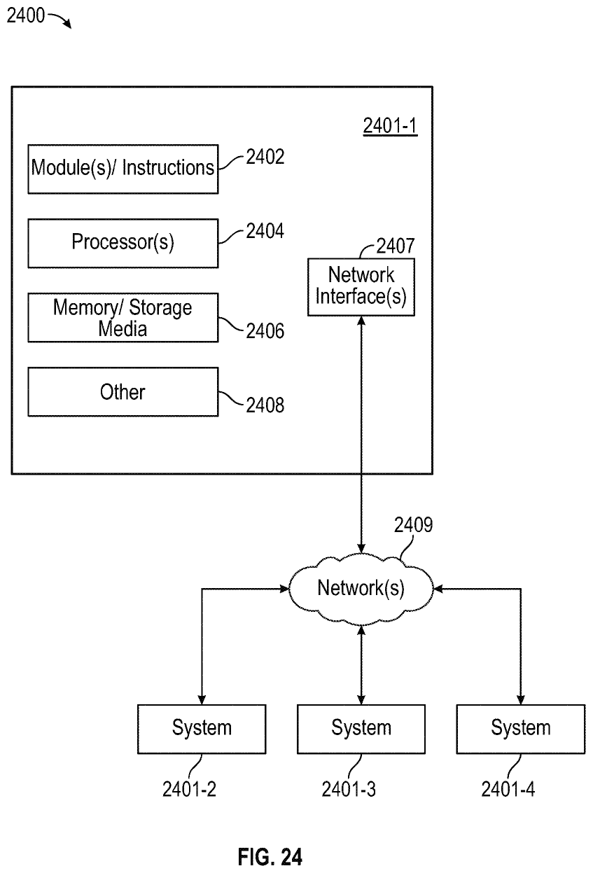

In some embodiments, the methods of the present disclosure may be executed by a computing system. FIG. 24 illustrates an example of such a computing system 2400, in accordance with some embodiments. The computing system 2400 may include a computer or computer system 2401-1, which may be an individual computer system 2401-1 or an arrangement of distributed computer systems such as systems 2401-2, 2401-3 and 2401-4. The computer system 2401-1 includes instructions 2402 that are configured to perform various tasks according to some embodiments, such as one or more methods disclosed herein. To perform these various tasks, the instructions 2402 can execute independently, or in coordination with, one or more processors 2404, which is (or are) connected to one or more storage media 2406. The processor(s) 2404 is (or are) also connected to a network interface 2407 to allow the computer system 2401-1 to communicate over a data network 2409 with one or more additional computer systems and/or computing systems, such as 2401-2, 2401-3, and/or 2401-4 (note that computer systems 2401-2, 2401-3 and/or 2401-4 may or may not share the same architecture as computer system 2401-1, and may be located in different physical locations, e.g., computer systems 2401-1 and 2401-2 may be located in a processing facility, while in communication with one or more computer systems such as 2401-3 and/or 2401-4 that are located in one or more data centers, and/or located in varying countries on different continents). As shown in the example of FIG. 24, one or more other components 2408 may be included.

A processor may include a microprocessor, microcontroller, processor module or subsystem, programmable integrated circuit, programmable gate array, or another control or computing device.

The storage media 2406 may be implemented as one or more computer-readable or machine-readable storage media. Note that while in the example embodiment of FIG. 24 storage media 2406 is depicted as within computer system 2401-1, in some embodiments, storage media 2406 may be distributed within and/or across multiple internal and/or external enclosures of computing system 2401-1 and/or additional computing systems. Storage media 2406 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, etc.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

1. A fluid displacement pump comprising:
a rotor; and
a stator, wherein the stator comprises an elastomeric material with a non-uniform thickness, and wherein the rotor and the stator have a one-to-two lobe ratio.

2. The fluid displacement pump of claim 1, wherein the elastomeric material comprises an inner profile and an outer profile.

3. The fluid displacement pump of claim 1, wherein the elastomeric material comprises an inner profile and an outer profile.

4. The fluid displacement pump of claim 3, wherein the outer profile is defined by a rectangle having opposing ends that are semielliptical.

5. The fluid displacement pump of claim 4, wherein the semielliptical ends are defined by a minor axis that is equal to a distance between opposing sides of the rectangle and a semi-major axis.

6. The fluid displacement pump of claim 1, wherein the elastomeric material comprises a major diameter, a minor diameter, a radial thickness along the major diameter and a radial thickness along the minor diameter.

7. The fluid displacement pump of claim 1, wherein the elastomeric material comprises a major diameter, a minor diameter, a radial thickness along the major diameter, a radial thickness along the minor diameter, and a radial thickness between the major diameter and the minor diameter that is greater than the radial thickness along the major diameter and that is greater than the radial thickness along the minor diameter.

8. The fluid displacement pump of claim 1, wherein the elastomeric material comprises a major diameter, a minor diameter, a radial thickness along the major diameter, a radial thickness between the major diameter and the minor diameter, and a radial thickness along the minor diameter that is less than the radial thickness along the major diameter and that is less than the radial thickness between the major diameter and the minor diameter.

9. The fluid displacement pump of claim 1, wherein the stator comprises a metal tube and wherein the elastomeric material is disposed within the metal tube.

10. The fluid displacement pump of claim 9, comprising a filler material that is disposed between an outer perimeter of the elastomeric material and an inner perimeter of the metal tube.

11. The fluid displacement pump of claim 10, wherein the elastomeric material comprises a tie-layer that binds the elastomeric material to the filler material.

12. The fluid displacement pump of claim 11, wherein the tie-layer generates at least a portion of the non-uniformity of the non-uniform thickness.

13. The fluid displacement pump of claim 1, comprising a motor operatively coupled to the rotor.

14. The fluid displacement pump of claim 1, comprising a fluid inlet and a fluid outlet.

15. The fluid displacement pump of claim 14, wherein the rotor is driven by fluid flowing from the fluid inlet to the fluid outlet.

16. The fluid displacement pump of claim 2, wherein the non-uniform thickness is characterized by a varying radial thickness measured between the inner profile and the outer profile.

17. The fluid displacement pump of claim 3, wherein the non-uniform thickness is characterized by the inner profile being a stadium and the outer profile not being a stadium.

18. The fluid displacement pump of claim 6, wherein the radial thickness along the major diameter is greater than the radial thickness along the minor diameter.

19. The fluid displacement pump of claim 1, wherein the elastomeric material comprises a primary elastomer liner that is co-vulcanized.

20. The fluid displacement pump of claim 1, wherein the stator comprises a primary stator liner is composed of nitrile rubber (NBR), hydrogenated nitrile rubber (HNBR), or fluoroelastome (FKM).
